(19) United States
(12) Patent Application Publication
(10) Pub. No.: US 2010/0222897 A1
(43) Pub. Date: Sep. 2, 2010

(54) DISTRIBUTED FAULT DIAGNOSIS

(75) Inventors: Liu Qiao, Ann Arbor, MI (US); Krishna Pattipati, Storrs, CT (US); Setu Madhavi Namburu, Boston, MA (US); Danil V. Prokhorov, Canton, MI (US)

Correspondence Address: GIFFORD, KRASS, SPRINKLE,;ANDERSON & CITKOWSKI, P.C., P.O. BOX 7021, TROY, MI, 48007-7021, US

(73) Assignees: Toyota Motor Engineering & Manufacturing North America, Inc., Erlanger, KY (US); The University of Connecticut, Farmington, CT (US)

(21) Appl. No.: 12/396,176

(22) Filed: Mar. 2, 2009

(51) Int. Cl. G05B 9/02; G06N 5/04

(52) U.S. Cl. 700/21; 709/202; 706/46

(57) ABSTRACT

A distributed diagnosis algorithm based on a multi-signal digraph model of an overall system is provided. In addition, a model enables the generation of a fault-test dependency matrix (D-matrix), which summarizes the detection capabilities of tests designed for faults associated with each node. Each row represents a fault state and each column represents a test.

### FIELD OF THE INVENTION

The present invention is related to fault diagnosis of a plant. In particular, the present invention is related to real-time distributed diagnosis for a plant.

### BACKGROUND OF THE INVENTION

Basic research in fault diagnosis has progressed significantly over the past four decades with well-established theoretical developments including consistency-based diagnosis [1], [2] from the artificial intelligence community and analytical redundancy techniques from the automatic control community [3].

In the automotive industry, motor vehicles can contain over 100 electronic control units (ECUs) and even more sensors, actuators, etc. These components have to communicate among each other, e.g. through a Controller Area Network (CAN) bus and the architecture of such electronic systems is transforming into a network of real-time distributed embedded control systems.

In such networks, a global diagnosis method, which collects the diagnostic information from all the subsystem controllers, is not practical due to high communication requirements and time delays induced by centralized diagnosis. The maintenance of such networks is also tedious for new prototypes, because they do not support plug-and-play capability. Consequently, different systems and methods of diagnosis are needed in order for development of improved machines to continue. As such, a system and/or method that provides improved real-time distributed diagnosis for a machine, plant and the like would be desirable.

### SUMMARY OF THE INVENTION

A system for real-time distributed diagnosis of a plant is provided. The system is operable with a plant that has a plurality of subsystems, each of the subsystems having one or more components that participate in the operation of the plant by performing one or more plant operations. In addition, the plant can have one or more sensors that detect the one or more plant operations and transmit data related thereto. The system can include an agent-based plant diagnostic network that has a plurality of subsystem resident agents, each of the subsystem resident agents being assigned to one of the plurality of subsystems. In addition, each of the subsystem resident agents is operable to run a test on one or more of the components of the assigned subsystem and provide an outcome of the test.

In addition to the subsystem resident agents, a plurality of diagnostic inference algorithms can be included. Each of the diagnostic inference algorithms can be assigned to one of the subsystem resident agents and be operable to monitor and assign a fault state to the outcome of the test run by the assigned subsystem resident agent. The fault state can be selected from “good”, “bad”, “suspect”, and “unknown”.

In some instances, the system can include a multi-signal digraph model of the plant and each of the diagnostic inference algorithms can be a function of the digraph model. In addition, the diagnostic inference algorithms can decompose a problem with the plant into domain specific subsystem models.

### BRIEF DESCRIPTION OF THE DRAWINGS

FIG. 1 is a schematic diagram of a plant having a plurality of subsystems;

FIG. 2 is a schematic diagram of a subsystem having a plurality of components with or without sensors;

FIG. 3 is a schematic diagram of a plant having a system for real-time distributed diagnosis according to an embodiment of the present invention;

FIG. 4 is a schematic flowchart of a process for real-time distributed diagnosis of a plant according to an embodiment of the present invention; and

FIG. 5 is a schematic illustration of a networked system with three subsystems in the form of a multi-signal digraph model.

### DETAILED DESCRIPTION OF THE PRESENT INVENTION

The present invention discloses a system for real-time distributed diagnosis of a plant that has a plurality of subsystems. As such, the present invention has utility as a diagnostic system.

The system can be used for the plant having the plurality of subsystems, each of the plurality of subsystems having one or more components that participate in the operation of the plant by performing one or more plant operations. In addition, one or more sensors can be included that detect the one or more plant operations and are operable to transmit data related thereto. The system can include an agent-based plant diagnostic network that has a plurality of subsystem resident agents (SRAs), each of the SRAs assigned to one of the subsystems and being operable to run a test on one or more of the components of the assigned subsystem. In addition, each of the SRAs can provide an outcome of the test that has been run.

In addition to the agent-based plant diagnostic network, a plurality of diagnostic inference algorithms can be included. Each of the diagnostic inference algorithms can be assigned to one of the SRAs and be operable to monitor and assign a fault state to the outcome of the test that is run by the particular SRA. The fault states assigned by the diagnostic inference algorithm can be selected from “Good”, “Bad”, “Suspect” and “Unknown”. Each of the SRAs is operable to receive data that is related to the detected plant operation from one or more of the sensors and transmit the data to a plant expert agent. In addition, each of the SRAs is also operable to transmit the fault state assigned by the diagnostic inference algorithm to the plant expert agent.

In some instances, the system can include a multi-signal digraph model of the plant. If such a model is provided, the diagnostic inference algorithms can be a function of the multi-signal digraph model. It is appreciated that each of the plurality of diagnostic inference algorithms can be assigned to a different subsystem resident agent of the plurality of subsystem resident agents and thus the diagnostic inference algorithms can decompose a problem with the plant into domain specific subsystem models. It is appreciated that the plant can be any type of machine or vehicle that has a plurality of subsystems, for example a motor vehicle.

A process for providing real-time distributed diagnosis to a plant can include providing a plant having a plurality of subsystems, the plurality of subsystems constituting at least part of the plant. Each of the subsystems can have at least one component that is operable to perform one or more predefined plant operations and at least one sensor that is operable to detect at least one of the one or more predefined plant operations performed by the at least one component. The at least one sensor is operable to transmit data related to the detected plant operation. An agent-based plant diagnostic network that has a plurality of SRAs is also provided, along with the plurality of distributed diagnostic algorithms as described above. The plant is operating with the subsystems contributing to the operation of the plant and the sensors detecting and transmitting information related to the operation of one or more components. The SRAs receive the information transmitted by the sensors, and may or may not run a test on at least one component. A given distributed diagnostic algorithm that is assigned to a particular subsystem and/or SRA can assign a fault state to the outcome of the test run by the SRA, the fault state transmitted to the plant expert agent.

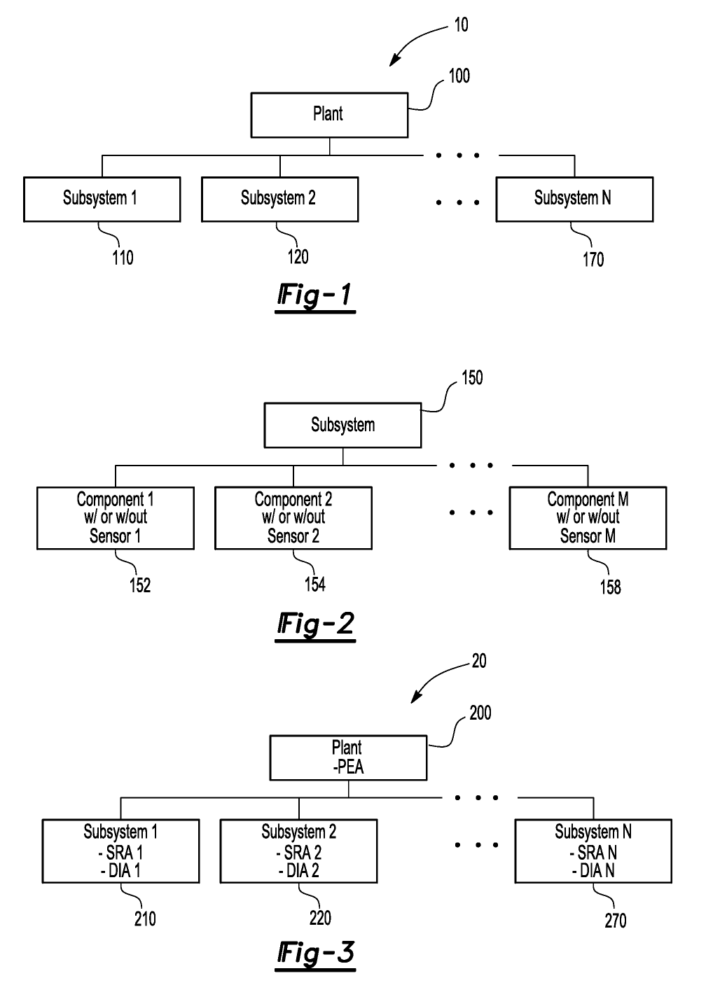

Turning now to FIG. 1, a schematic diagram of a plant having a plurality of subsystems is shown generally at reference numeral 10. The plant 100 can include a Subsystem 1 110, a Subsystem 2 120 up to a Subsystem N 170. It is appreciated that the subsystems can constitute at least a portion of the plant 100 and participate in the operation of the plant thereof. It is further appreciated that the plant 100 can be a motor vehicle and the subsystems can be systems within the motor vehicle such as a power train system, an occupant safety system, a steering system and the like.

Referring now to FIG. 2, a schematic diagram of a particular subsystem 150 is shown with a plurality of components. For example, the subsystem 150 can have a first component 152, a second component 154 up to an M component 158. As shown in this figure, each of the components may or may not have a sensor that is assigned to it. It is appreciated that the sensor can detect one or more plant operations that is performed by a component.

Turning now to FIG. 3, a schematic diagram of a system for a plant according to an embodiment of the present invention is shown generally at reference numeral 20. The plant 200 can have a plant expert agent (PEA) and each subsystem 210, 220, . . . 270 can have a subsystem resident agent (SRA) and a diagnostic inference algorithm (DIA). It is appreciated that each subsystem shown in FIG. 3 can have one or more components with or without one or more sensors as illustrated in FIG. 2. During operation, the one or more components within a given subsystem perform a predefined plant operation that is detected by one or more sensors that can transmit data related thereto. In some instances, the data from the sensor is transmitted to an SRA for the subsystem and the DIA can assign a fault state thereto. In the alternative, the SRA can run a test on one or more of the components within the subsystem and produce an outcome for the test. In this instance, the DIA can assign a fault state to the outcome of the test. It is appreciated that in some instances, the DIA may instruct the SRA to perform the test, or in the alternative, the PEA may instruct the SRA to perform the test.

After a fault state has been assigned to the data received by the SRA, the fault state can be transmitted to the PEA. It is appreciated that the PEA can run a plant-wide diagnostic analysis, thereby producing a plant-wide diagnosis.

In order to better illustrate the inventive distributed diagnosis algorithm, development of an example distributed diagnosis algorithm is described below, along with comparison of the developed algorithm with a centralized diagnosis algorithm using real-world examples.

### I. Development of Centralized Algorithm

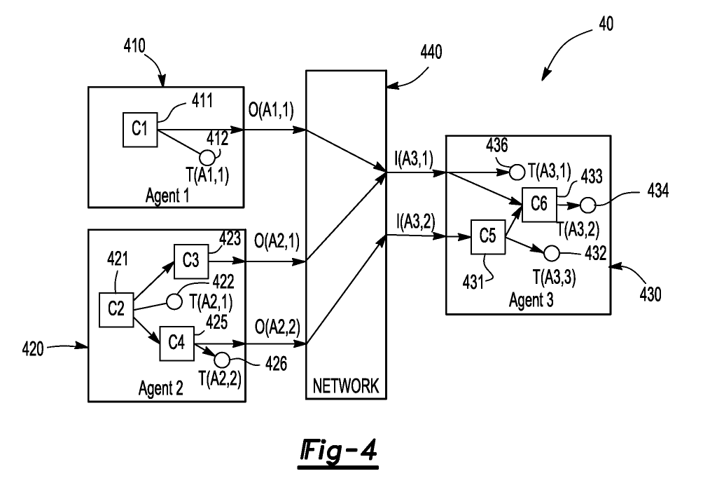

Referring to FIG. 4, a three node networked system composed of three multi-signal digraph models is illustrated, each digraph model representing a subsystem of the overall system. There are three agents, Agent1 410, Agent2 420 and Agent3 430, with odd numbered boxes 411, 413, etc. representing entities such as failure sources, fault states, causes and the like, and even numbered circles 412, 422, etc. representing symptoms such as tests, effects, etc. It is appreciated that the details of digraph diagnostic modeling may be found in reference [4]. For development of a centralized diagnosis problem, the D-matrix of the entire system is assumed known a priori. For ease of exposition, a one-to-one correspondence between components (C) and failure sources (FS) is assumed. As such, the diagnosis problem consists of the following:

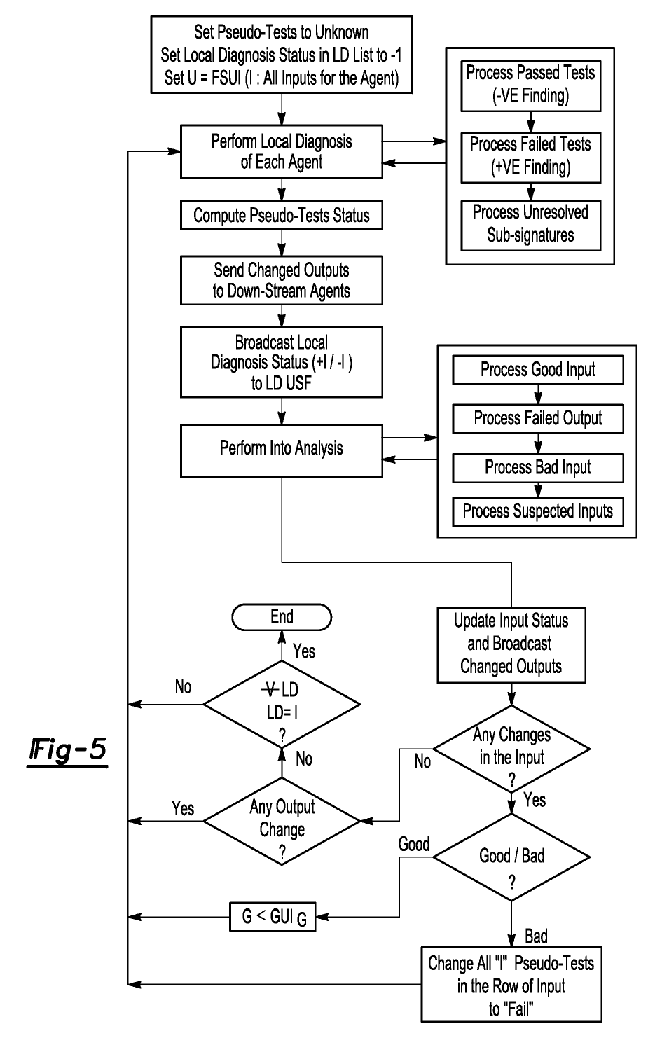

1) a set of m potential failure sources FS={fs₁, . . . , fsₘ};
2) a set of n available binary tests (or events, alarms, features) T {t₁, . . . , tₙ}; and
3) a D-matrix, D, having dimension m×n, describing the diagnostic capabilities of tests. Each test tⱼ for 1≦j≦n, corresponds to a column in the D-matrix: dⱼ^{T}=[d₁ⱼ, d₂ⱼ, . . . , dₘⱼ]. In addition, dᵢⱼ=1 implies that test tⱼ fails (alarm j rings) if failure source fsᵢ is the cause of failure. Conversely, dᵢⱼ=0 indicates that failure source fsᵢ is not detected by test tⱼ. For example and for illustrative purposes only, the D-matrix for entities 411, 421, . . . 433 (C1-C6) in FIG. 5 for a centralized diagnosis is shown in Table 1.

TABLE 1

| | T | | | | | |
|---|---|---|---|---|---|---|
| | t₁ | t₂ | t₃ | t₄ | t₅ | t₆ |
| FS | T_{(A1,1)} | T_{(A2,1)} | T_{(A2,2)} | T_{(A3,1)} | T_{(A3,2)} | T_{(A3,3)} |
| fs₁ = C1 | 1 | 0 | 0 | 1 | 1 | 0 |
| fs₂ = C2 | 0 | 1 | 1 | 1 | 1 | 1 |
| fs₃ = C3 | 0 | 0 | 0 | 1 | 1 | 0 |
| fs₄ = C4 | 0 | 0 | 1 | 0 | 1 | 1 |
| fs₅ = C5 | 0 | 0 | 0 | 0 | 1 | 1 |
| fs₆ = C6 | 0 | 0 | 0 | 0 | 1 | 0 |

A diagnosis problem can be defined by a triple (D, T, X), where D={dᵢⱼ|i=1 . . . m, j=1 . . . n} is the dependency matrix, T {tⱼ|j=1 . . . n} is the set of test outcomes and X{Good, Bad, Suspected, Unknown} is the set of four distinct states associated with each component in the system. In addition, a support SPⱼ of a test tⱼ can be a set of failure sources (rows of the D-matrix) with a nonzero element in the column corresponding to tⱼ. As such, a real-time centralized (RTC) diagnosis inference algorithm [5] for the diagnosis problem (D, T, X) can be stated as:

Algorithm RTC: Given the sequences of test outcomes T and D-matrix.

```
Step 1: Initialize:
  Set states of all failure sources to Unknown:
    U = FS, B = Ø, S = Ø, G = Ø, F = Ø
Step 2: Process Passed Tests:
  i. Find the union of test signatures of passed tests:
    ∪t_{j passed} SPⱼ
  ii. Find new good components using the union of test signatures of
    passed tests:
    ΔG ← (∪tⱼ passed SPⱼ)\G
  iii. Update Fault sets - remove good components from Suspected and
    Unknown sets:
    G ← G∪ΔG, S ← S\ΔG, U ← U\ΔG.
Step 3: Process Failed Tests:
  i. Store failure sub-signatures pending resolution:
    fₖ ← {SPₖ\G},F = ∪t_{k failed} fₖ
  ii. Add Unknown covered components to the set of Suspected
    components:
    S ← ∪{fₖ}, U ← U\{fₖ}
Step 4: Process unresolved sub - signatures:
  i. Update the unexplained failed test set F by removing the new good
    components:
    fₖ ← {fₖ\ΔG},F = ∪t_{k failed} fₖ
  ii. Update Bad component list B by identifying one - for - sure Bad
    components:
    If |fₖ| = 1, B ← B ∪fₖ,ΔB ← ΔB ∪fₖ.
  iii. Remove sub-signatures explained by newly identified Bad
    components:
    If fₖ ∩ ΔB ≠ Ø, remove fₖ from F
    If F_{sb} = S ∩ B ≠ Ø, remove F_{sb} from S
    If F_{gb} = G ∩ B ≠ Ø, remove F_{gb} from G
```

In this algorithm, G represents the set of Good components, B represents the set of Bad components, S represents the set of Suspected components and U represents the set of Unknown components.

A diagnosis for the diagnosis problem can be defined as D=∪Dᵢ with a minimal cardinality diagnosis defined as D^{mc}={|Dⱼ|=min_{Di∈D} |Dᵢ|,Dⱼ∈D} as taught in reference [1]. It is appreciated that the diagnosis D=∉Dᵢ follows the principle of parsimony (or Occam's razor), i.e. a minimum set of faulty components can explain the observed findings. Such an approach implicitly implies multiple fault diagnosis by computing the hitting sets using conflict sets. However, for large complex systems with thousands of failure sources (components) and tests, the number of hitting sets will be enormous. As such, all unique diagnoses are included in the set B with the remaining multiple diagnoses included in the set S, excluding failure sources in the set B.

A scope SCᵢ (signature) of a failure source can be a set of tests (columns of the D-matrix) with a nonzero element in the row corresponding to si. In addition, a set E of tests is said to be D-Complete if E is finite and for any component failing, ∃tⱼ∈E such that tⱼ=1. Such a “D-completeness” property guarantees detectability, i.e. any component fault will cause some test(s) to fail. It is appreciated that if a set of tests for a D-matrix is D-complete, there will be no Unknown components in the diagnosis. Furthermore, the Unknown failure source set from algorithm RTC will contain all the failure sources which have empty scope (SC=Ø). Stated differently, the Unknown failure source set from the algorithm RTC will have all the failure sources with undetectable faults.

Given the above, the diagnosis problem can be summarized by the following theorem.

Theorem 1: The diagnosis solution using RTC for the diagnosis problem (D, T, X) is:

B=∪{Dᵢ:|Dᵢ|=1}

S=∪{|Dᵢ|1}\B

U=Åfsᵢ,Scᵢ=Ø

G=FS\(B∪S┘U)

As an illustration of the theorem, taking test results (0,0,0,1,1,0) for the network illustrated in FIG. 4 affords a diagnosis of D₁={fs₃} and D₂={fs₃, fs₆}. In addition, the minimal cardinality diagnosis is D₁={fS₃} and the diagnosis from (D, T, X) is G={fs₁, fs₂, fs₄, fs₅}, B={fS₃}, S={fs₆} and U=Ø. As such, it is apparent that the minimal cardinality diagnosis overlooked fs₆ as a potential failure source.

### II. Development of Distributed Diagnosis Algorithm

It is appreciated that a possible solution to the distributed diagnosis problem is to keep a D-matrix for an entire system in a central diagnosis processing unit. In this manner, the central unit can collect test results from all the agents in the system and obtain a global diagnosis directly using the algorithm RTC. Although this approach can give reduction in memory and computational requirements for local agents, it has major shortcomings. For example, it can be difficult to keep the overall model up to date as engineering design changes occur, particularly since such a solution does not support plug-and-play for future control and monitoring developments and/or enhancements.

In the alternative the inventive distributed diagnostic approach does not require a central unit. Since the overall digraph model is decomposed into individual digraph models for each subsystem node, the local agent does not know, at least initially, the input(s)/output(s) status of its local model. However, two modifications to each local diagnosis agent can be made to handle this uncertainty. In particular, treat each subsystem input as a potential failure source and treat each subsystem output as a test point.

By treating each subsystem input as a potential failure source, account for the fact that a bad output from upstream can cause tests within the local subsystem to fail is provided. As such, all the subsystem inputs are listed as failure sources and in the D-matrix there are more rows corresponding to input faults. By treating each subsystem output as a test point, the test points are pseudo-tests, whose outcomes are inferred by the local diagnosis agent. Therefore, the D-matrix has the pseudo-tests added as columns. In addition, and unlike regular tests, there are four outcomes for pseudo-tests: Pass, Fail, Suspect and Unknown. After making these two modifications, the D-matrices for the three local models/agents Agent1 410, Agent2 420 and Agent3 430, become as shown in Tables 2, 3 and 4, respectively.

TABLE 2

T

| | t₁ | |
|---|---|---|
| FS | T_{(A1,1)} | O_{(A1,1)} |
| fs₁ = C1 | 1 | 1 |

TABLE 3

T

| | t₁ | t₂ | t₃ | t₄ |
|---|---|---|---|---|
| FS | T_{(A2,1)} | T_{(A2,2)} | O_{(A2,1)} | O_{(A2,2)} |
| fs₁ = C2 | 1 | 1 | 1 | 1 |
| fs₂ = C3 | 0 | 0 | 1 | 0 |
| fs₃ = C4 | 0 | 1 | 0 | 1 |

TABLE 4

| | T | | |
|---|---|---|---|
| | t₁ | t₂ | t₃ |
| FS | T_{(A3,1)} | T_{(A3,2)} | T_{(A3,3)} |
| fs₁ = I_{(A3,1)} | 1 | 1 | 0 |
| fs₂ = I_{(A3,2)} | 0 | 1 | 1 |
| fs₃ = C5 | 0 | 1 | 1 |
| fs₄ = C6 | 0 | 1 | 0 |

It is appreciated that the basic principle of distributed diagnosis is that each agent performs its own diagnosis first using the centralized diagnosis algorithm RTC based on its D-matrix after the modifications. Then, each agent computes the output status. Finally, each local agent broadcasts all changed output/input status results to downstream and upstream agents. After obtaining information from neighboring agents, each agent iteratively revises its diagnosis based on information from upstream (input status) and downstream (output status) agents until it can no longer update the input/output status information, i.e. convergence occurs.

For illustrative purposes, an example step-by-step process is described.

### III. Example Process

### A. Initialization

To start the distributed diagnosis process, the following initializations can be performed for each agent.

### 1. Pseudo-Test List

To avoid storing a digraph in each agent, the pseudo-test list Lₜⱼ, which contains all the outputs reached by test tⱼ, can be pre-computed via reachability analysis and stored in the memory. For example, the pseudo-test list L_{T(A2,1)} for test T_{(A2,1)} of Agent2 is L_{T(A2,1)}={O(A_{2,1)}, O_{(A2,2)}}.

### 2. Output List

For input Iᵢ, there is an output list L_{Ii} that contains all the pseudo tests (outputs) from the upstream agents that are linked to this input. All the pseudo tests in this list are initialized as Unknown. For example, the input list L_{I(A3,1)} for input I_{(A3,1)} of Agent3 is L_{I(A3,1)}={O_{(A2,1)}(U), O_{(A1,1)}(U)}.

### 3. Local Diagnosis Status List

Each agent Aᵢ tracks the local diagnosis status of its own and its neighboring agents. The local diagnosis (LD) status list LDᵢ contains the agents' name and their LD status. There are two status indicators for local diagnosis. These are ‘1’ if the local diagnosis (or local diagnosis update) and the computation of pseudo-test status at the local agent are done and ‘−1’ if the local diagnosis is still running. All the LD status are initialized as −1.

### B. Local Diagnosis Based on D-Matrix

After the two modifications of each local agent detailed above are made, the D-matrix for the local agent will add rows for inputs (potential failure sources) and columns for outputs (pseudo-tests). For the inputs (potential failure sources), the inference will be performed using algorithm RTC. For the outputs (pseudo-tests), the initial values are set to Unknown.

### C. Compute Pseudo-Test Status

The status of pseudo-tests after the local diagnosis are computed as follows:

Rule (9): If a test tⱼ in the subsystem fails, set all the output pseudo-tests in Lₜⱼ that are reachable downstream from this test as having Failed. For example, the downstream pseudo-test list for test T_{(A2,1)} is {O_{(A2,1)},O_{(A2,2)}}. If T_{(A2,1)} fails, the pseudo-tests {O_{(A2,1)},O_{(A2,2)}} will be set to fail.

Rule (10): If all components within a subsystem reaching an output test are good, declare this pseudo-test as Pass. To execute the above rule, we can use the D-matrix as follows. For each pseudo-test tⱼ, corresponding to a column in the D-matrix, dⱼ^{T} if ∀dᵢⱼ=1, fsᵢ [symbol] G, set this pseudo-test to Pass. For example, for Agent2 in FIG. 5, if tests T_{(A2,1)} and T_{(A2,2)} pass, the local diagnosis is G={C2,C4}, U={C3}. Since d₁₄=1 and d₃₄=1 (in III) and their corresponding failure sources {C2,C4} [symbol] G, set pseudo-test O_{(A2,2)} to Pass.

### D. Input/Output Analysis at Downstream Agent

After the agents perform their local diagnoses, they coordinate with each other to update their input/output status and local diagnoses. By the nature of digraph, the downstream agent receives upstream agent's outputs. Therefore, it is appropriate that the input/output analysis be performed at the downstream agent. For example, illustrative examples for the input/output analysis under different scenarios can be:

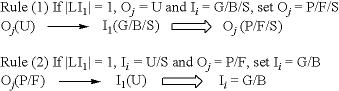

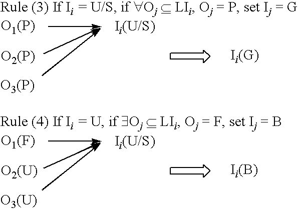

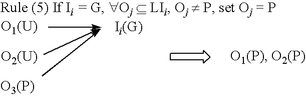

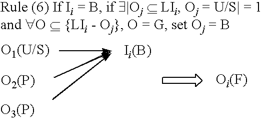

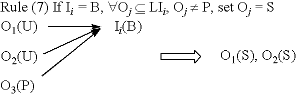

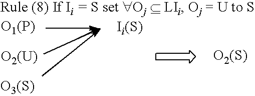

It is appreciated that during the input/output analysis, there are input/output status changes and these changes will affect the input/output analysis, if the analysis is not sequenced correctly. In addition to the input/output analysis the input/output analysis (IOA) algorithm guaranteeing correct execution order can be:

Algorithm IOA: Given the output list LO and initial
input/output status for an agent.

```
Step 1: Process Good Input:
  FOR All Iᵢ, Iᵢ = G
    IF |LIᵢ| = 1 and Oⱼ = U/S, set Oⱼ = P (Rule 1)
    ELSE Set∀Oⱼ [symbol]  LIᵢ, Oⱼ ≠ P to P (Rule 5)
  END FOR
Step 2: Process Failed Outputs:
  FOR All Oⱼ, Oⱼ = F
    IF Oⱼ [symbol]  LIᵢ, set Iᵢ = B (Rule (2,4))
  END FOR
Step 3: Process Bad Inputs:
  FOR All Iᵢ ,Iᵢ = B
    IF |LIᵢ| = 1 and Oⱼ = U/S, set Oⱼ = F (Rule 1)
      ELSE IF |Oⱼ = U/S| = 1 and ∀O [symbol]
    {LIᵢ\Oⱼ},O = P
      set Oⱼ = B (Rule (6))
    ELSE ∀Oⱼ [symbol]  LIᵢ, Oⱼ ≠ P, set Oⱼ = S (Rule (7))
  END FOR
Step 4: Process Suspected Inputs:
FOR ALL Iᵢ, Iᵢ = S
IF |LIᵢ| = 1 and Oⱼ = U, set Oⱼ = S (Rule (1))
ELSE set ∀Oⱼ [symbol]  LIᵢ, Oⱼ = U to S (Rule (8))
```

### E. Local Diagnosis Update

After an agent receives changes for the inputs/outputs, the local diagnosis is updated. Since input changes may trigger output changes, inputs are processed first. For all inputs (I_{G}) that change to Good, the set of Good components are updated as G←G∪I_{G} and each input that changes to Bad, the pseudo-tests that have 1 in the row of this input are updated to Fail (if it did not Fail). Thereafter, the agent treats the changed outputs (pseudo-tests) as new test results and updates the local diagnosis according to Steps 2-4 of algorithm RTC as describe above.

### F. Communication Requirement Between Local Agents

The asynchronous communication among agents are triggered by the input/output status changes, and LD status change. The real-time global (RTG) diagnosis algorithm can be summarized as:

Algorithm RTG: Given the sequences of test outcomes T, D-matrix
(after special treatment), pseudo-test list, output list and local
diagnosis (LD) list for each agent.

```
For each agent:
Initialization:
1) set the pseudo-tests in pseudo-test list to Unknown;
2) set the local diagnosis status in LD list to −1;
3) Step 1 in Algorithm RTC, change U = FS to U = FS ∀ I
(where I are all inputs for this agent).
Step 1: Local Diagnosis:
Perform Step 2 -Step 4 for Algorithm RTC.
Store G, S, U, B, fₖ, F.
Step 2: Compute Pseudo - tests Status:
  Compute pseudo-test status as in Section III-C, send the changed
  outputs to the downstream agent and broadcast local diagnosis status
  (−1/1) to agents in LD list.
Step 3: Input/Output Analysis:
  If downstream agent i, ∀LDⱼ ε LDᵢ, LDⱼ = 1, ∀Iⱼ, if Iⱼ(new) ≠ Iⱼ(old)
  or L_{Ij} (new) ≠ L_{Ij} (old), perform Input/Output analysis based
  on Section III-D, update its inputs status, and broadcast
  the changed outputs.
Step 4: Local Diagnosis Update:
  For each input that changes to Bad, change all the pseudo-tests that are
  1 in the row of this input to Fail (if it is not Fail).
  For all inputs (I_{G}) that change to Good, G ← G ∀ I_{G}.
  Based on the changes to pseudo-tests, go to Step 1 to update local
  diagnosis.
    Algorithm converges when there is no input/output change and
    ∀LD,LD = 1.
```

### G. Proof of Correctness of Algorithm RTG

To prove the correctness of the RTG algorithm, two lemmas are first introduced.

Lemma 1: The Local diagnoses {Gᵢ, Bᵢ, Sᵢ, Uᵢ}, Aᵢ∈A for each agent at each iteration are disjoint.

Proof: Intuitively, the local diagnosis in the diagnosis problem (D, T, X) provides the status (Good/Bad/Suspected/Unknown) for each failure source and these failure sources at each agent are independent of failure sources associated with other agents. Also UFSI=FS. Therefore, all the local diagnoses are disjoint.

Lemma 2: Given current local diagnosis {Gᵢ^{old}, Bᵢ^{old}, Sᵢ^{old}, Uᵢ^{old}} and input/output changes, the result of local diagnosis update {Gᵢ^{new}, Bᵢ^{new}, Sᵢ^{new}, Uᵢ^{new}} is such that |G^{new}≧|G^{old}|, |B^{new}|≧|B^{old}|, |U^{new}|≦|U^{old}| and |S^{new}|≦|S^{old}|. The local diagnosis update always generates the status for a failure source in the following order:
Unknown→Suspected→Good/Bad

Proof: From the algorithm RTG and according to Lemma 1, the local diagnoses are disjoint, which means that Gᵢ [symbol] Gᵢ^{g} and Bᵢ [symbol] Bᵢ^{g}. For an input status change, each input (potential failure sources) will move from Unknown/Suspected→Bad/Good. For the pseudo-test (output) change, the failure sources will change their status from Unknown→Suspected/Bad/Good or Suspected→Bad/Good.

The result of algorithm RTG is given by the following theorem.

Theorem 2: Given the global diagnosis {G^{g}, B^{g}, S^{g}, U^{g}} based on the entire system D-matrix and test outcomes, if all local diagnoses {Gᵢ, Bᵢ, Sᵢ, Uᵢ} for all agents Aᵢ∈A are available and LDᵢ=1, then, when Algorithm RTG converges, {G^{g}, B^{g}, S^{g}, U^{g}}∪{Gᵢ, Bᵢ, Sᵢ, Uᵢ}.

Proof: From Lemma 1, it follows that all the local diagnoses are disjoint. Lemma 2 states that each local diagnosis update will always improve the diagnosis for failure sources in the order Unknown→Suspected→Good/Bad. When there is no input/output change and all the local diagnoses have converged (LD=1), the global diagnosis is the union of all the local diagnoses of failure sources (excluding the inputs).

A summary of the step-by-step process is shown in FIG. 5.

### IV. Real-World Models

In order to test the real-time global (RTG) diagnosis algorithm and compare it with the real-time centralized (RTC) algorithm a number of real-world models with reliable tests were evaluated. The sizes of the real-world models (m, n) varied from (8, 4) to (5206, 3720) in the number of failure sources, m, and number of tests, n. The real-world models included were:
Cassette Player model consists of a power-supply, tape head, pre-amplifier, power-amplifier and a three-way speaker system.
UH-60 Helicopter Transmission System is a high-level model of a UH-60 Black Hawk helicopter. It mainly models the transmission system.
Automotive system models the entire vehicle based on electrical schematics. It consists of engine subsystem, driver compartment, brakes and lights.
UH-60 Helicopter 1553 Bus involves a series of communication buses connecting helicopter components, sensors and computers.

Early External Thermal Control System is a model of a temporary thermal system, which is needed until the components of the permanent ETCS (External Thermal Control System) are launched and activated in a space station. It consists of radiators, heat exchangers, pumps, lines, valves, etc.
Document Matching system is an integrated mail system of Pitney Bowes, which combines printing and matched mass mailing facilities in one machine.
Landing Gear Control Unit is the control unit for the landing gear system of a helicopter.
Outer Flight Control System is a model of the outer-loop flight control system of a helicopter.

Detailed information about the models, such as the density of the D-matrix, average in-degree and average out-degree of each model is listed in Table 5.

TABLE 5

| | | No. | | Density | Average | Average | No. of | Time (sec) | |
|---|---|---|---|---|---|---|---|---|---|
| | No. of | of | No. of | of | In- | Out- | Failed | for | Time (sec) |
| Models | Sources | Tests | Subsystems | D-matrix | degree | degree | Tests | RTG (T^{a}) | for RTC |
| Cassette | 8 | 4 | 2 | 46.88% | 3.75 | 1.88 | 4 | 0.04 | 0.02 |
| Player | | | | | | | | (0.02) | |
| UH-60 | 160 | 51 | 3 | 0.60% | 0.96 | 0.31 | 8 | 0.14 | 0.05 |
| Helicopter | | | | | | | | (0.05) | |
| Transmission | | | | | | | | | |
| System | | | | | | | | | |
| Automotive | 179 | 140 | 3 | 1.12% | 2.02 | 1.58 | 13 | 0.09 | 0.17 |
| System | | | | | | | | (0.06) | |
| UH-60 | 175 | 61 | 3 | 9.39% | 16.43 | 5.73 | 11 | 0.05 | 0.03 |
| Helicopter | | | | | | | | (0.02) | |
| 1553 Bus | | | | | | | | | |
| Early | 78 | 143 | 3 | 38.78% | 30.25 | 55.46 | 98 | 0.09 | 0.03 |
| External | | | | | | | | (0.03) | |
| Thermal | | | | | | | | | |
| Control | | | | | | | | | |
| System | | | | | | | | | |
| Document | 259 | 180 | 4 | 0.93% | 2.41 | 1.67 | 14 | 0.17 | 0.06 |
| Matching | | | | | | | | (0.05) | |
| System | | | | | | | | | |
| Landing | 2080 | 1319 | 10 | 20.54% | 427.39 | 270.89 | 320 | 2.86 | 2.48 |
| Gear Control | | | | | | | | (0.29) | |
| Unit | | | | | | | | | |
| Outer Flight | 5206 | 3720 | 20 | 1.16% | 60.37 | 43.13 | 82 | 61.83 | 18.92 |
| Control | | | | | | | | (3.09) | |
| System | | | | | | | | | |

^{a}Approximate execution time T for each agent = Execution time/No. of subsystems

As shown in Table 5, both the RTC algorithm and the RTG algorithm work with the same efficiency on models with less than 500 failure sources and the approximate execution tome of the RTG algorithm is comparable to the execution time of the RTC algorithm. However for larger systems, it is apparent from the approximate execution time for the RTG algorithm (seconds in parenthesis) is significantly shorter than the execution time for the RTC algorithm.

In summary, an agent based real-time distributed diagnosis algorithm is provided to support a networked embedded distributed system. A distributed diagnosis algorithm (RTG) decomposes the vehicle diagnosis problem into domain-specific (digraph models) subsystems. By communicating input/output status indicators between neighboring agents, each agent acquires information about its neighbors and improves its local diagnosis iteratively. The algorithm converges after all the local agents finish their local diagnosis (or update) and there is no communication (“silence”) over the network. In addition, the correctness of the algorithm is provided. The distributed diagnosis algorithm RTG has been evaluated on several real-world examples and the algorithm was found to be superior to the centralized diagnosis algorithm RTC for large systems with many subsystems.

### REFERENCES

[1] R. Reiter, “A theory of diagnosis from first principles,” Artificial Intelligence, vol. 32, no. 1, pp. 57-95, 1987.
[2] J. de Kleer and B. Williams, “Diagnosing multiple faults,” Artificial Intelligence, vol. 32, no. 1, pp. 97-130, April 1987.
[3] R. Isermann, “Supervision, fault-detection and fault-diagnosis methods—an introduction,” Control Engineering Practice, vol. 5, no. 5, pp. 639-652, 1997.
[4] S. Deb, K. R. Pattipati, V. Raghavan, M. Shakeri, and R. Shrestha, “Multi-signal flow graphs: a novel approach for system testability analysis and fault diagnosis,” Aerospace and Electronic Systems Magazine, vol. 10, no. 5, pp. 14-25, 1995.

1. A system for real-time distributed diagnosis of a plant having a plurality of subsystems, each of the plurality of subsystems having one or more components that participate in the operation of the plant by performing one or more plant operations and one or more sensors that detect the one or more plant operations and transmit data related to a detected plant operation, said system comprising:
an agent-based plant diagnostic network having a plurality of subsystem resident agents, each of said plurality of subsystem resident agents assigned to one of the plurality of subsystems and operable to run a test on one or more of the components of the assigned subsystem and provide an outcome of said test;
a plurality of diagnostic inference algorithms, each of said plurality of diagnostic inference algorithms assigned to one of said plurality of subsystem resident agents and operable to monitor and assign a fault state to said outcome of said test run by said assigned subsystem resident agent.

2. The system of claim 1, wherein said fault state assigned to said outcome by said diagnostic inference algorithm is selected from the group consisting of good, bad, suspect and unknown.

3. The system of claim 1, wherein each of said plurality of subsystem resident agents is operable to receive said data related to the detected plant operation from the one or more sensors and transmit said data to a plant expert agent.

4. The system of claim 1, wherein each of said plurality of subsystem resident agents is operable to transmit said fault state to a plant expert agent.

5. The system of claim 1, further comprising a multi-signal digraph model of the plant.

6. The system of claim 5, wherein said diagnostic inference algorithm is a function of said multi-signal digraph model.

7. The system of claim 1, wherein each of said plurality of diagnostic inference algorithms is assigned to a different subsystem resident agent of said plurality of subsystem resident agents.

8. The system of claim 7, wherein said diagnostic inference algorithms decompose a problem with the plant into domain specific subsystem models.

9. A plant having real-time distributed diagnostic capabilities, said plant comprising:
a plurality of subsystems, said plurality of subsystems constituting at least part of said plant;
each of said plurality of subsystems having at least one component that is operable to perform one or more predefined plant operations and at least one sensor that is operable to detect at least one of said one or more predefined plant operations performed by said at least one component, said at least one sensor also operable to transmit data related to said detected plant operation;
a plurality of distributed diagnostic algorithms, each of said plurality of distributed diagnostic algorithms assigned to at least one of said plurality of subsystems and operable to receive said data from said at least one sensor from said assigned subsystem and assign a fault state to said data thereby resulting in said fault state being assigned to said at least one component.

10. The plant of claim 9, further comprising a plurality of subsystem resident agents, each of said plurality of subsystem resident agents assigned to at least one of said plurality of subsystems and operable to receive said data from said at least one sensor of said at least one subsystem.

11. The plant of claim 10, wherein each of said plurality of distributed diagnostic algorithms is embedded within a subsystem resident agent of said plurality of subsystem resident agents.

12. The plant of claim 11, wherein each of said plurality of distributed diagnostic algorithms is embedded within a different subsystem resident agent.

13. The system of claim 9, wherein said fault state assigned to said outcome by said diagnostic inference algorithm is selected from the group consisting of good, bad, suspect and unknown.

14. The system of claim 9, wherein each of said plurality of subsystem resident agents is operable to transmit said fault state to a plant expert agent.

15. The system of claim 9, further comprising a multi-signal digraph model of the plant.

16. The system of claim 15, wherein each of said plurality of diagnostic inference algorithms is a function of said multi-signal digraph model.

17. A process for providing real-time distributed diagnosis to a plant, the process comprising:
providing a plant having a plurality of subsystems, the plurality of subsystems constituting at least part of the plant;
each of the plurality of subsystems having at least one component that is operable to perform one or more predefined plant operations and at least one sensor that is operable to detect at least one of the one or more predefined plant operations performed by the at least one component, the at least one sensor also operable to transmit data related to the detected plant operation;
providing an agent-based plant diagnostic network having a plurality of subsystem resident agents;
each of the plurality of subsystem resident agents assigned to one of the plurality of subsystems and operable to run a test on one or more of the components of the assigned subsystem and provide an outcome of the test;
providing a plurality of distributed diagnostic algorithms;
each of the plurality of diagnostic inference algorithms assigned to one of the plurality of subsystem resident agents and operable to monitor and assign a fault state to the outcome of the test run by the assigned subsystem resident agent;
operating the plant whereby the at least one component in at least part of the plurality of subsystems performs one or more predefined plant operations and at least part of the plurality of diagnostic inference algorithms assigns a fault state to the components performing predefined plant operations.

18. The process of claim 17, wherein at least part of the plurality of diagnostic inference algorithms iteratively assigns a fault state to the components performing predefined plant operations.

19. The process of claim 18, wherein the subsystem resident agents communicate the assigned fault states with neighboring subsystem resident agents.

20. The process of claim 19, wherein communicating the assigned fault states with neighboring subsystem resident agents decomposes the diagnosis of a problem for the plant into domain specific subsystem models.
